(19) United States
(12) Patent Application Publication
(10) Pub. No.: US 2011/0096877 A1
(43) Pub. Date: Apr. 28, 2011

(54) WIRELESS RECEIVER AND FEEDBACK METHOD

(75) Inventors: Ryohei Kimura, Osaka (JP); Kenichi Miyoshi, Osaka (JP); Katsuhiko Hiramatsu, Osaka (JP)

(73) Assignee: PANASONIC CORPORATION, Osaka (JP)

(21) Appl. No.: 12/920,030

(22) PCT Filed: Mar. 5, 2009
(86) PCT No.: PCT/JP2009/000995

§ 371 Date: Jan. 10, 2011

(30) Foreign Application Priority Data
Mar. 6, 2008 (JP) 2008-056555

(51) Int. Cl. H04L 1/02

(52) U.S. Cl. 375/347

(57) ABSTRACT

Disclosed is a wireless receiver and feedback method for reducing the amount of CQI feedback in a MIMO channel. A channel estimation unit (103) uses a received pilot signal to estimate the channel matrix for each RB between respective transceiver antennas, and then performs eigenvalue decomposition of the estimated channel matrix to find eigenvalues and eigenvectors. A feedback data generator (104) is provided with a feedback bit table that correlates the number of quantized bits for the averaged CQI to be transmitted for each eigenvalue and the number of quantized bits for the CQI in each RB, and then reduces the number of quantized bits for the averaged CQI Xₖ commensurate with the magnitude of the eigenvalue number k. The feedback data generator (104) averages eigenvalues found by the channel estimator (103) for each RB, converts the averaged eigenvalue to a CQI for each eigenvalue number, and generates feedback data from the CQI for each eigenvalue with the number of quantized bits according to the feedback table.

### TECHNICAL FIELD

The present invention relates to a radio reception apparatus and feedback method.

### BACKGROUND ART

MIMO (Multiple-Input Multiple-Output) is a technology in which a transmission apparatus and reception apparatus are both equipped with a plurality of antennas, and perform high-speed, large-volume information transmission. Specifically, a plurality of data can be transmitted at the same time using the same frequency, enabling a high transmission speed to be achieved.

In this MIMO transmission method, a transmission method called eigenmode transmission is known. In eigenmode transmission, information concerning a channel between transmitting and reception apparatuses is found by means of channel estimation, and found channel information (channel matrix H) correlation matrix H^{H}H undergoes eigenvalue decomposition to find eigenvalues Λ and eigenvectors W. This is illustrated in equation 1. Then parallel transmission equivalent to the number of eigenvalues is possible by using WH^{H} as a transmission weight and W^{H} as a reception weight. A conceptual diagram of eigenmode transmission is shown in FIG. 1.

$$\begin{matrix}( Equation 1 ) & \\ \begin{matrix}{H}^{H} H = W Λ {W}^{H} \\ = ( \begin{matrix}{w}_{1} & {w}_{2} & {w}_{3} & {w}_{4}\end{matrix} ) ( \begin{matrix}{λ}_{1} & 0 & 0 & 0 \\ 0 & {λ}_{2} & 0 & 0 \\ 0 & 0 & {λ}_{3} & 0 \\ 0 & 0 & 0 & {λ}_{4}\end{matrix} ) \\ {( \begin{matrix}{w}_{1} & {w}_{2} & {w}_{3} & {w}_{4}\end{matrix} )}^{H}\end{matrix} \\ {W}^{H} {H}^{H} HW = diag ( {λ}_{1} , {λ}_{2} , {λ}_{3} , {λ}_{4} ) \\ Λ \text{:} Diagonal matrix , W \text{:} Unitary matrix & [ 1 ]\end{matrix}$$

Here, λₖ is the k'th eigenvalue, and the relationship λ₁>λ₂>λ₃>λ₄ applies. Transmission weight wₖ is assigned to k'th stream sₖ, and transmission is performed using the k'th eigenvalue λₖ channel. Consequently, the smaller eigenvalue number (stream number) k, the higher is the transmission quality that can be achieved.

A technology for improving cell throughput in a 3GPP (3rd Generation Partnership Project) LTE (Long Term Evolution) downlink is frequency scheduling (multi-user scheduling). Each terminal feeds back to the base station a CQI (Channel Quality Indicator) that is decided based on an SINR (Signal to Interference and Noise Ratio) for each RB (Resource Block), and the base station allocates communication resources to terminals using these CQIs.

The base station allocates a communication resource preferentially to a terminal that feeds back a higher CQI. Consequently, since the number of terminals that feed back a high CQI increases as the number of terminals increases, there is an improvement in cell throughput (peak data rate and frequency utilization efficiency). CQI feedback methods include Best-M reporting and DCT (Discrete Cosine Transform) reporting.

FIG. 2 shows an overview of Best-M reporting. In Best-M reporting, an average CQI (represented by X bits) of an entire transmission band (N_{RB}) and the top M RBs with a high CQI level are selected, and CQIs corresponding to the selected RBs (the CQI of each RB being represented by Y bits) and the positions of the selected RBs (represented by log₂(_{NRB}C_{M}) bits) are fed back. By this means, a total of X+YM+log₂(_{NRB}Cₘ) bits are fed back. Number of quantization bits Y of the top M CQIs is represented by a difference value from the average CQI.

FIG. 3 shows the CQI feedback format in Best-M reporting. Here, a case is shown in which X=5 bits, Y=3 bits, and M=5. The base station demodulates the Best-M reporting feedback information, and reproduces the SINR of each RB.

FIG. 4 shows an overview of DCT reporting. In DCT reporting, a direct current (DC) component (represented by X bits) and M frequency components comprising low frequency components (represented by Y bits per frequency) are fed back from among the results obtained by performing DCT conversion of the SINR of each RB. By this means, a total of X+MY bits are fed back. In DCT reporting, M frequency components are fed back in order starting with the lowest frequency, and therefore the kind of position information included in Best-M reporting is not necessary.

FIG. 5 shows the CQI feedback format in DCT reporting. Here, a case is shown in which X-5 bits, Y=5 bits, and M=4. The base station performs IDCT (Inverse Discrete Cosine Transform) conversion of the DCT reporting feedback information, and reproduces the SINR of each RB.

When CQIs are fed back in above-described MIMO communication, SINRₖ of the k'th stream is used as a quality indicator, and CQI conversion of an SINR is performed for each stream in the case of Best-M reporting, while DCT conversion of an SINR is performed for each stream in the case of DCT reporting. Also, when CQIs are fed back in above-described eigenmode transmission, eigenvalue λₖ is used as a quality indicator instead of SINRₖ, and CQI conversion of eigenvalue λₖ is performed in the case of Best-M reporting, while DCT conversion of eigenvalue λₖ is performed in the case of DCT reporting.

Non-Patent Document 1: 3GPP, R1-062954, LG Electronics, “Analysis on DCT based CQI reporting Scheme”, RAN1#46-bis, Seoul, Oct. 9-13, 2006

### DISCLOSURE OF INVENTION

### Problems to be Solved by the Invention

However, with a MIMO channel, the same CQI feedback format as for a SIMO (Single-Input Multiple-Output) is applied to each stream, and therefore the number of CQI feedbacks increases in proportion to the number of MIMO channel streams, as shown in FIG. 6.

It is an object of the present invention to provide a radio reception apparatus and feedback method that reduce the amount of CQI feedback in a MIMO channel.

### Means for Solving the Problem

A radio reception apparatus of the present invention employs a configuration having: a reception section that receives via a plurality of antennas a signal transmitted from a plurality of antennas; a channel estimation section that estimates a channel matrix between transmission antennas and reception antennas using a pilot signal in the received signal, and finds eigenvalues by performing eigenvalue decomposition of an estimated channel matrix; a feedback information generation section that converts the eigenvalue to a CQI for each eigenvalue number, reduces a number of quantization bits of an average CQI in each stream, a number of top CQIs that are fed back, or a number of top CQI quantization bits by a number corresponding to an eigenvalue number, and generates CQI feedback information; and a transmission section that transmits the feedback information.

A radio reception apparatus of the present invention employs a configuration having: a reception section that receives via a plurality of antennas a signal transmitted from a plurality of antennas; a channel estimation section that estimates a channel matrix between transmission antennas and reception antennas using a pilot signal in the received signal, and finds eigenvalues by performing eigenvalue decomposition of an estimated channel matrix; a feedback information generation section that performs DCT conversion of the eigenvalue for each eigenvalue number, reduces a number of quantization bits of a DC component in each stream, a number of frequency components other than a DC component, or a number of quantization bits of a frequency component other than a DC component by a number corresponding to an eigenvalue number, and generates CQI feedback information; and a transmission section that transmits the feedback information.

A feedback method of the present invention has: a channel estimation step of estimating a channel matrix between a plurality of transmission antennas and a plurality of reception antennas, and finding eigenvalues by performing eigenvalue decomposition of an estimated channel matrix; a feedback information generation step of converting the eigenvalue to a CQI for each eigenvalue number, reducing a number of quantization bits of an average CQI in each stream, a number of top CQIs that are fed back, or a number of top CQI quantization bits by a number corresponding to an eigenvalue number, and generating CQI feedback information; and a transmitting step of transmitting the feedback information.

### ADVANTAGEOUS EFFECTS OF INVENTION

The present invention enables the amount of CQI feedback in a MIMO channel to be reduced.

### BRIEF DESCRIPTION OF DRAWINGS

FIG. 1 is a conceptual diagram showing eigenmode transmission;

FIG. 2 is a drawing showing an overview of Best-M reporting;

FIG. 3 is a drawing showing a CQI feedback format according to Best-M reporting;

FIG. 4 is a drawing showing an overview of DCT reporting;

FIG. 5 is a drawing showing a CQI feedback format according to DCT reporting;

FIG. 6 is a drawing showing how the number of CQI feedbacks increases in proportion to the number of streams;

FIG. 7 is a block diagram showing the configuration of a reception apparatus according to Embodiment 1 of the present invention;

FIG. 8 is a drawing showing a feedback bit table according to Embodiment 1 of the present invention;

FIG. 9 is a drawing showing eigenvalue fluctuation in the frequency domain;

FIG. 10 is a drawing showing how CQI conversion is performed on eigenvalues of first through fourth streams;

FIG. 11 is a block diagram showing the configuration of a transmission apparatus according to Embodiment 1 of the present invention;

FIG. 12 is a drawing showing a feedback bit table according to Embodiment 2 of the present invention;

FIG. 13 is a drawing showing a feedback bit table according to Embodiment 3 of the present invention;

FIG. 14 is a drawing showing how DCT conversion is performed on eigenvalues of first through fourth streams;

FIG. 15 is a drawing showing a feedback bit table according to Embodiment 4 of the present invention;

FIG. 16 is a drawing showing a feedback bit table according to Embodiment 5 of the present invention;

FIG. 17 is a drawing showing a feedback bit table according to Embodiment 6 of the present invention;

FIG. 18 is a drawing showing a feedback bit table according to Embodiment 7 of the present invention;

FIG. 19 is a drawing showing a feedback bit table according to Embodiment 8 of the present invention; and

FIG. 20 is a drawing showing a feedback bit table according to Embodiment 9 of the present invention.

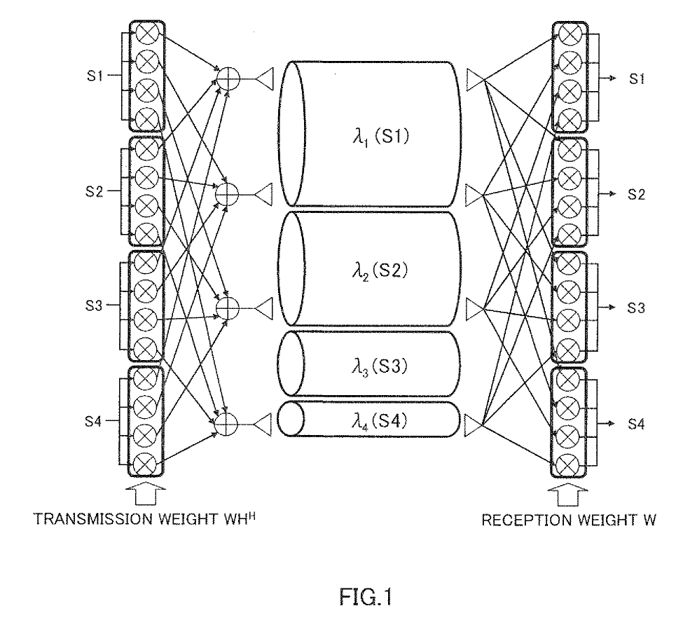

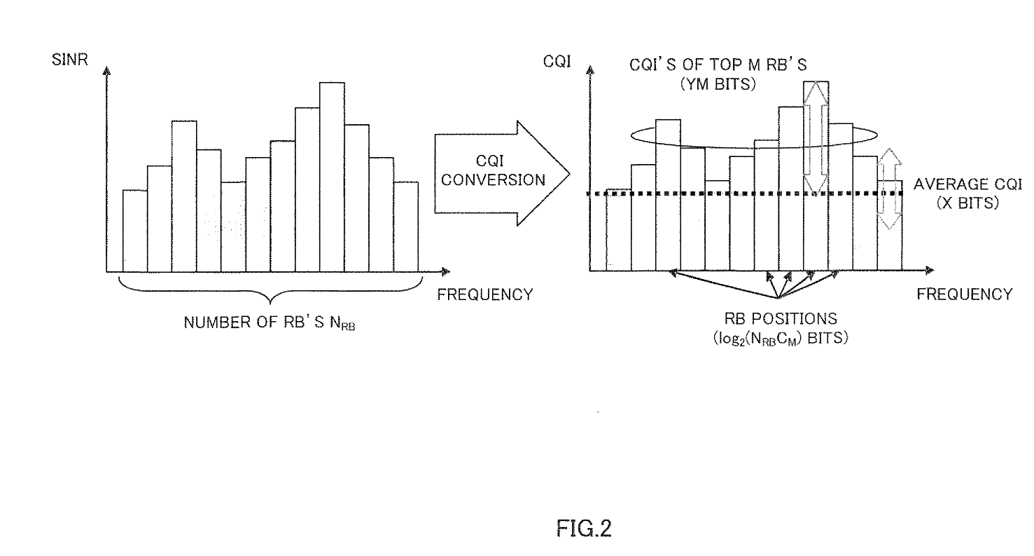

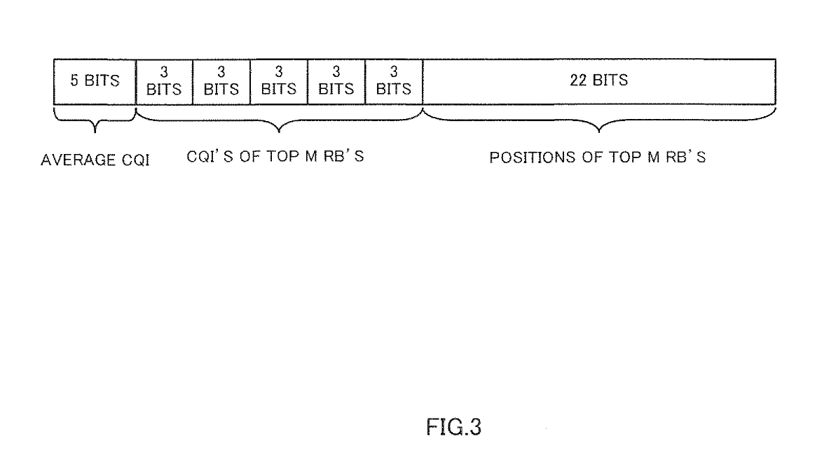

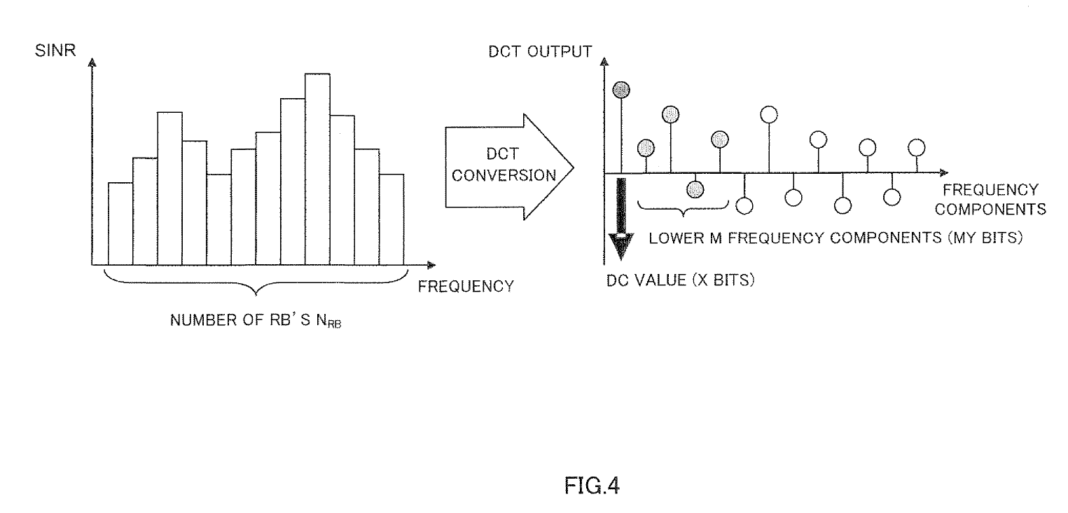

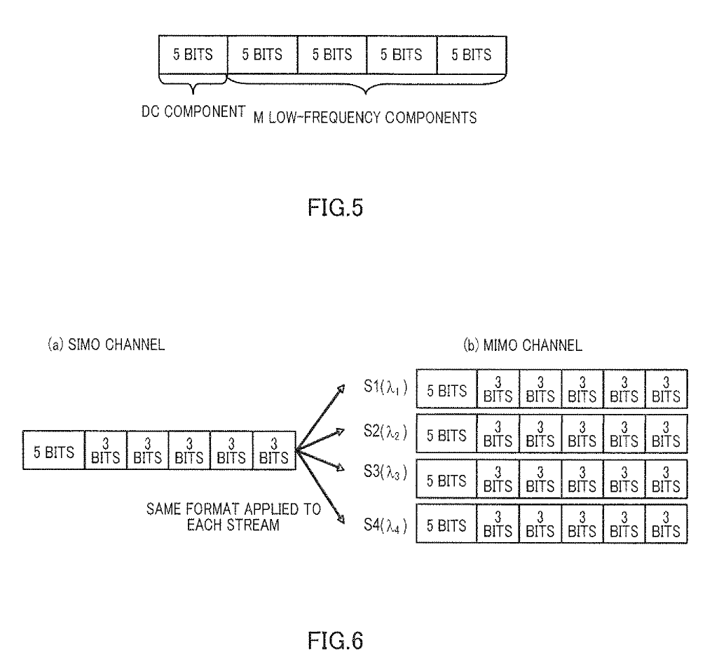

### BEST MODE FOR CARRYING OUT THE INVENTION

Now, embodiments of the present invention will be described in detail with reference to the accompanying drawings.

### Embodiment 1

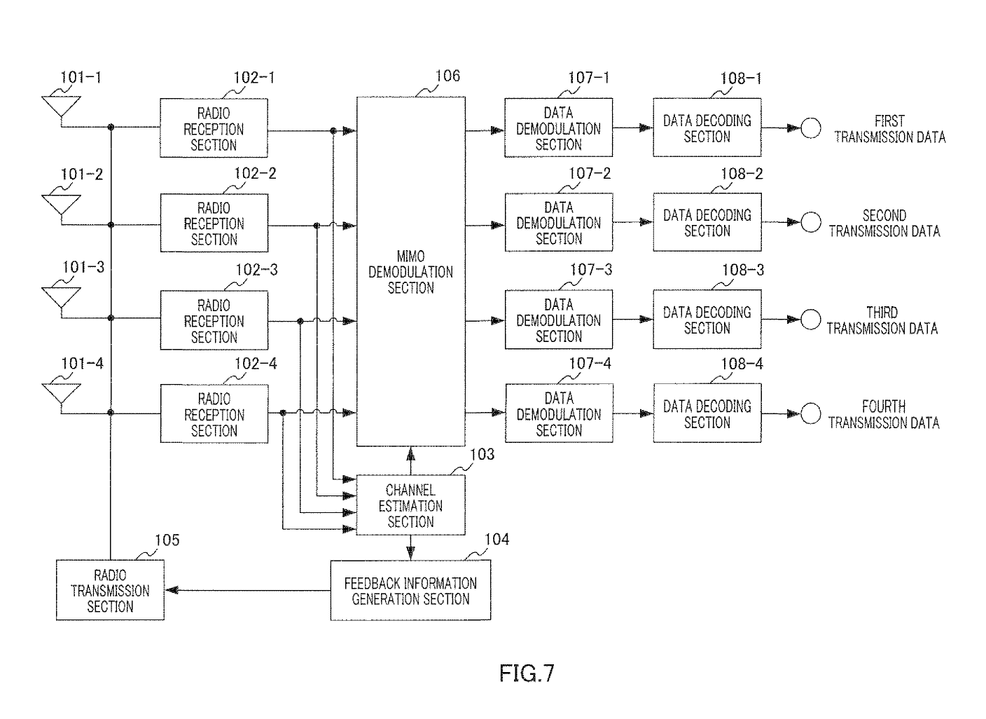

FIG. 7 is a block diagram showing the configuration of a reception apparatus according to Embodiment 1 of the present invention. Here, a case in which there are four antennas is described. Radio reception sections 102-1 through 102-4 down-convert signals received via corresponding antennas 101-1 through 101-4 to baseband signals, output data signals in the received signals to MIMO demodulation section 106, and output pilot signals in the received signals to channel estimation section 103.

Channel estimation section 103 uses pilot signals output from radio reception sections 102-1 through 102-4 to estimate a channel matrix for each RB between the respective transmitting and reception antennas, and performs eigenvalue decomposition of the estimated channel matrix to find eigenvalues and eigenvectors. The found eigenvalues and eigenvectors are output to feedback information generation section 104 as transmission weights, and values obtained by multiplying the channel matrix by the eigenvectors are output to MIMO demodulation section 106 as reception weights. A channel matrix is a matrix of channel gain between transmission antennas and reception antennas.

Feedback information generation section 104 is equipped with a feedback bit table that associates a number of quantization bits of an average CQI to be transmitted for each eigenvalue with a number of quantization bits of a CQI in each RB, Feedback information generation section 104 averages eigenvalues output from channel estimation section 103 for each RB, and converts the averaged eigenvalue to a CQI for each eigenvalue number (stream). Feedback information generation section 104 generates feedback information from the CQI for each eigenvalue with a number of quantization bits according to the feedback bit table, and outputs this to radio transmission section 105. Details of feedback information generation section 104 will be given later herein.

Radio transmission section 105 up-converts feedback information output from feedback information generation section 104, and transmits this information from antennas 101-1 through 101-4.

MIMO demodulation section 106 multiplies data signals output from radio reception sections 102-1 through 102-4 by a reception weight output from channel estimation section 103, and separates the streams. The separated streams are output to data demodulation sections 107-1 through 107-4 respectively.

Data demodulation sections 107-1 through 107-4 convert the streams output from MIMO demodulation section 106 from modulation symbols to soft decision bits, and output these to data decoding sections 108-1 through 108-4. Data decoding sections 108-1 through 108-4 perform channel decoding of the soft decision bits output from data demodulation sections 107-1 through 107-4, and restore the transmission data.

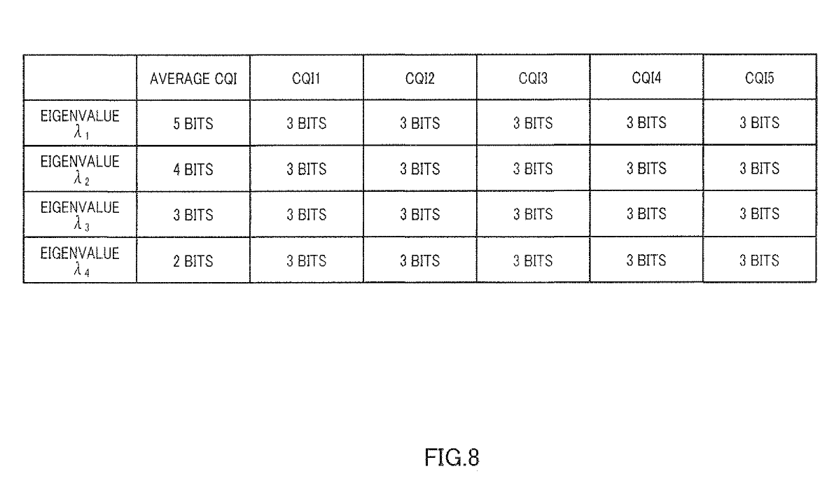

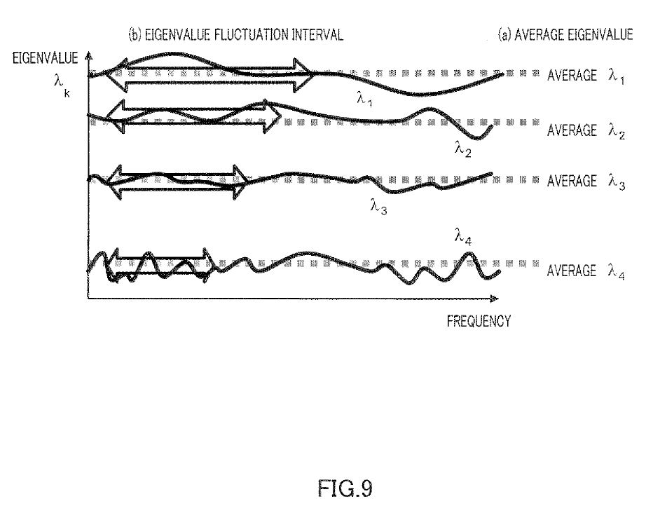

Feedback information generation by feedback information generation section 104 described above will now be explained in detail. Feedback information generation section 104 is provided with a feedback bit table in which number of average CQI quantization bits Xₖ is decreased as eigenvalue number k increases, as shown in FIG. 8. Here, it is assumed that the average CQI of eigenvalue λ₁ is 5 bits, the average CQI of eigenvalue λ₂ is 4 bits, the average CQI of eigenvalue λ₃ is 3 bits, and the average CQI of eigenvalue λ₄ is 2 bits. This is because, as shown in FIG. 9, the average value of an eigenvalue (“AVERAGE EIGENVALUE” in FIG. 9) decreases—that is, the value of the average CQI decreases—as eigenvalue number k increases. It is also assumed that the number of CQIs that are fed back, Mₖ, is 5, and the number of quantization bits of the top Mₖ CQIs, Yₖ, is 3.

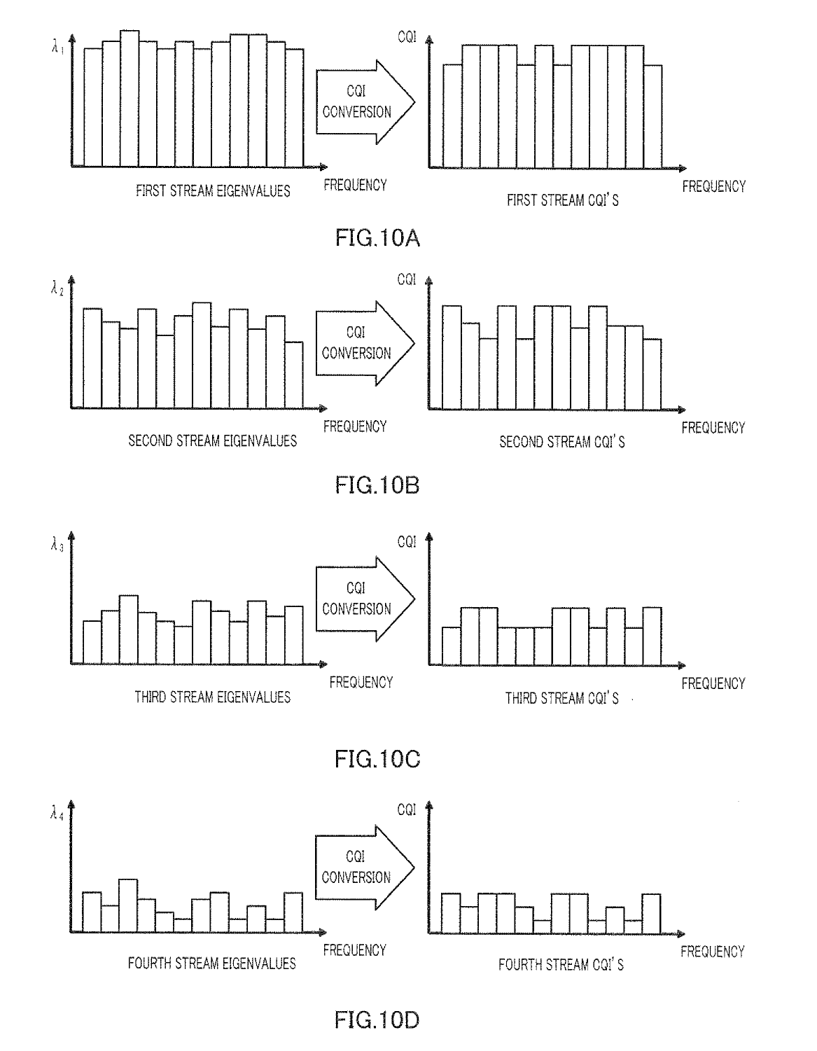

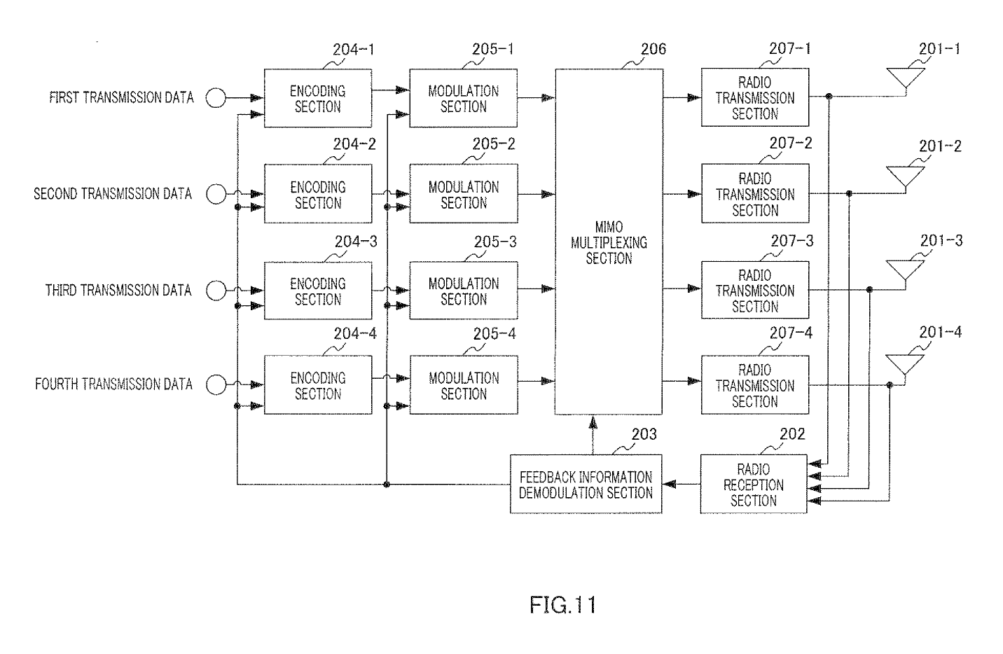

As shown in FIG. 10A through FIG. 10D, feedback information generation section 104 converts eigenvalues averaged for each RB to CQIs for each eigenvalue number (stream), and generates feedback information from the CQI for each eigenvalue with a number of quantization bits according to the feedback bit table.

By decreasing number of average CQI quantization bits Xₖ as eigenvalue number k increases in this way, the number of feedback bits can be reduced.

FIG. 11 is a block diagram showing the configuration of a transmission apparatus according to Embodiment 1 of the present invention. Here, a case in which there are four antennas is described. Radio reception section 202 receives feedback information fed back from a reception apparatus via antennas 201-1 through 201-4, down-converts the received feedback information to a baseband signal, and outputs this to feedback information demodulation section 203.

Feedback information demodulation section 203 is provided with the same feedback bit table as provided in feedback information generation section 104 of the reception apparatus shown in FIG. 7, and demodulates the feedback information output from radio reception section 202 based on the feedback bit table and acquires a transmission weight and CQI (channel coding rate and modulation level). The acquired transmission weight is output to MIMO multiplexing section 206, the modulation level is output to encoding sections 204-1 through 204-4, and the modulation level is output to modulation sections 205-1 through 205-4. Details of feedback information demodulation section 203 will be given later herein.

Encoding sections 204-1 through 204-4 encode respective input transmission data using a channel coding rate output from feedback information demodulation section 203, and output the encoded data to modulation sections 205-1 through 205-4. Modulation sections 205-1 through 205-4 modulate encoded data output from encoding sections 204-1 through 204-4 using a modulation level output from feedback information demodulation section 203, and output modulation symbols to MIMO multiplexing section 206.

MIMO multiplexing section 206 multiplies modulation symbols output from modulation sections 205-1 through 205-4 by a transmission weight output from feedback information demodulation section 203, and convert them to transmission streams. MIMO multiplexing section 206 multiplexes all the transmission streams and outputs them to radio transmission sections 207-1 through 207-4.

Radio transmission sections 207-1 through 207-4 up-convert transmission streams output from MIMO multiplexing section 206, and transmit them from antennas 201-1 through 201-4.

Feedback information demodulation by feedback information demodulation section 203 described above will now be explained in detail. Feedback information demodulation section 203 is provided with the feedback bit table shown in FIG. 8.

Since the numbers of CQI feedback bits assigned to each stream differ, feedback information demodulation section 203 references the feedback bit table and acquires number of k'th stream average CQI quantization bits Xₖ, the number of CQIs that are fed back, Mₖ, and the number of CQI quantization bits of those CQIs, Yₖ. Feedback information demodulation section 203 demodulates feedback information based on acquired Xₖ, Mₖ, and Yₖ, and acquires a transmission weight and CQI (channel coding rate and modulation level). According to the feedback bit table shown in FIG. 8, X₁=5, X₂=4, X₃=3, X₄=2, Mₖ=5, and Yₖ=3.

Thus, according to Embodiment 1, when CQI feedback is performed based on Best-M reporting, the amount of CQI feedback can be reduced by decreasing the number of average CQI quantization bits as the eigenvalue number increases.

### Embodiment 2

The configurations of a reception apparatus and transmission apparatus according to Embodiment 2 of the present invention are similar to the configurations shown in FIG. 7 and FIG. 11 of Embodiment 1, with only some functions differing, and therefore FIG. 7 and FIG. 11 are used here and duplicate descriptions are omitted.

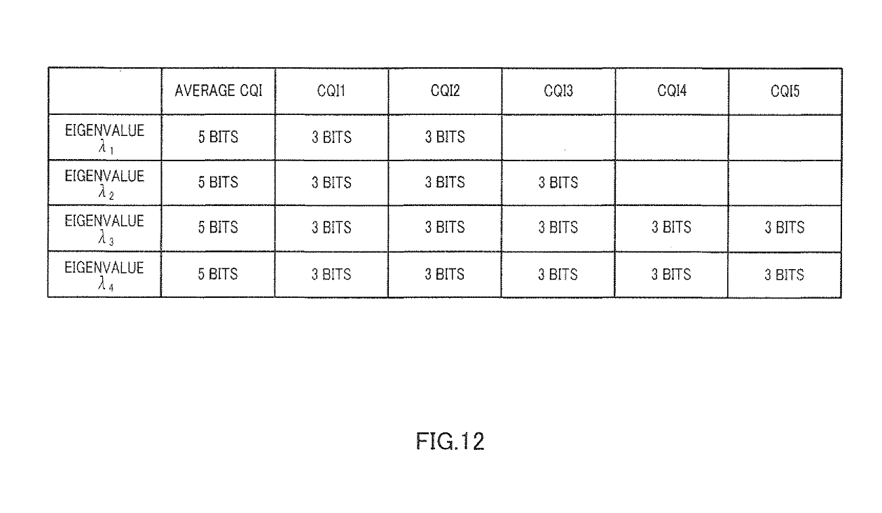

Feedback information generation section 104 and feedback information demodulation section 203 according to Embodiment 2 of the present invention are provided with a feedback bit table in which the number of CQIs that are fed back, Mₖ, is decreased as eigenvalue number k decreases, as shown in FIG. 12. Here, it is assumed that number of fed-back CQIs M₁ for eigenvalue λ₁ is 2, number of fed-back CQIs M₂ for eigenvalue λ₂ is 3, number of fed-back CQIs M₃ for eigenvalue λ₃ is 4, and number of fed-back CQIs M₄ for eigenvalue λ₄ is 5. This is because, as shown in FIG. 9, the eigenvalue fluctuation cycle in the frequency domain lengthens as eigenvalue number k decreases. It is also assumed that the number of average CQI quantization bits is 5, and the number of quantization bits of CQIs that are fed back is 3.

Thus, according to Embodiment 2, when CQI feedback is performed based on Best-M reporting, the amount of CQI feedback can be reduced by decreasing the number of CQIs that are fed back as the eigenvalue number decreases.

### Embodiment 3

The configurations of a reception apparatus and transmission apparatus according to Embodiment 3 of the present invention are similar to the configurations shown in FIG. 7 and FIG. 11 of Embodiment 1, with only some functions differing, and therefore FIG. 7 and FIG. 11 are used here and duplicate descriptions are omitted.

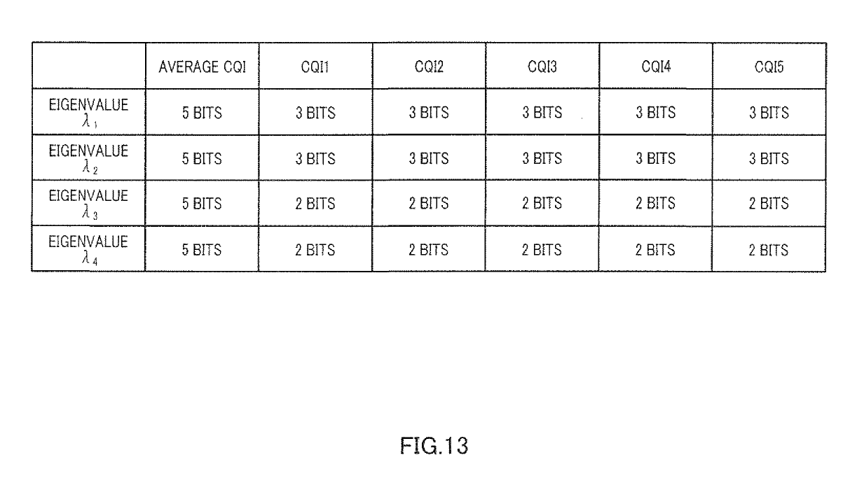

Feedback information generation section 104 and feedback information demodulation section 203 according to Embodiment 3 of the present invention are provided with a feedback bit table in which number of CQI quantization bits Yₖ is decreased as eigenvalue number k increases, as shown in FIG. 13. Here, it is assumed that numbers of quantization bits Y₁ and Y₂ of CQIs fed back for eigenvalue λ₁ and eigenvalue λ₂ are 3, and numbers of quantization bits Y₃ and Y₄ of CQIs fed back for eigenvalue λ₃ and eigenvalue λ₄ are 2. This is because the influence of CQI feedback precision on link adaptation precision decreases as eigenvalue number k increases. It is also assumed that the number of average CQI quantization bits is 5, and the number of CQIs that are fed back is 5.

Thus, according to Embodiment 3, when CQI feedback is performed based on Best-M reporting, the amount of CQI feedback can be reduced by decreasing the number of CQI quantization bits as the eigenvalue number increases.

### Embodiment 4

The configurations of a reception apparatus and transmission apparatus according to Embodiment 4 of the present invention are similar to the configurations shown in FIG. 7 and FIG. 11 of Embodiment 1, with only some functions differing, and therefore FIG. 7 and FIG. 11 are used here and duplicate descriptions are omitted.

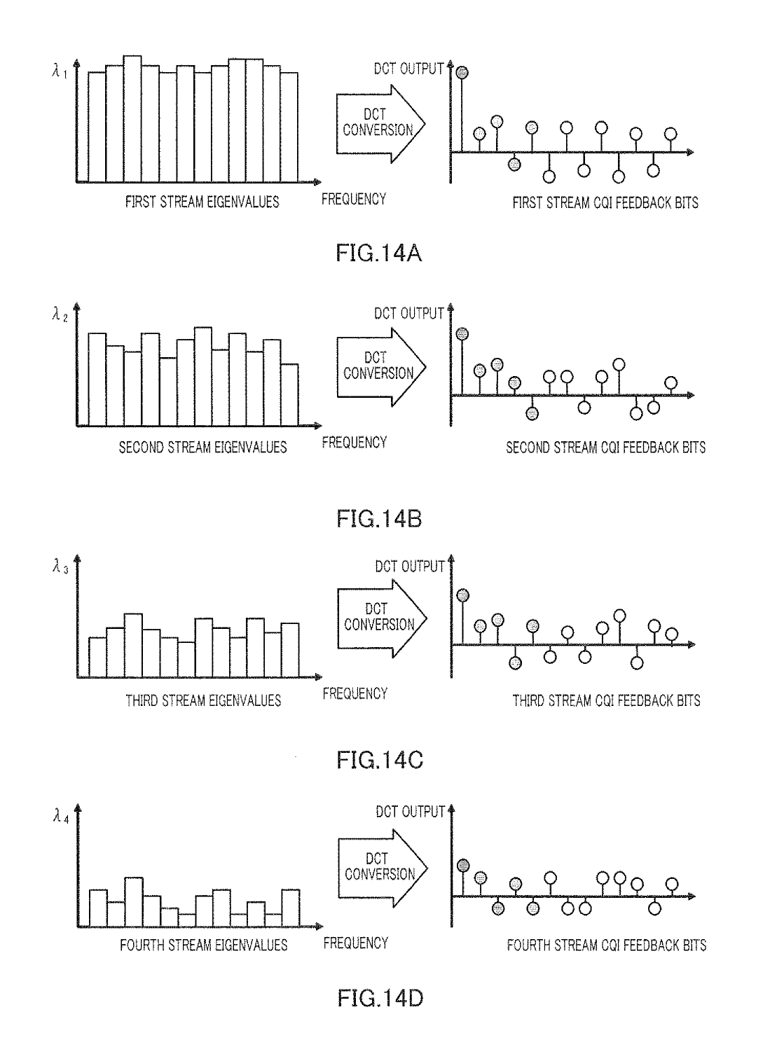

Feedback information generation section 104 according to Embodiment 4 of the present invention averages eigenvalues output from channel estimation section 103 for each RB, and performs DCT conversion of eigenvalues averaged for each RB for each eigenvalue number (stream), as shown in FIG. 14A through FIG. 14D. Feedback information generation section 104 is equipped with a feedback bit table that mutually associates number of DC component quantization bits Xₖ to be transmitted for each eigenvalue, number of frequency components Mₖ, and number of quantization bits Yₖ of those frequency components. Feedback information generation section 104 generates feedback information from a DCT-converted CQI DC component and Mₖ frequency components for each eigenvalue according to the feedback bit table, and outputs this to radio transmission section 105.

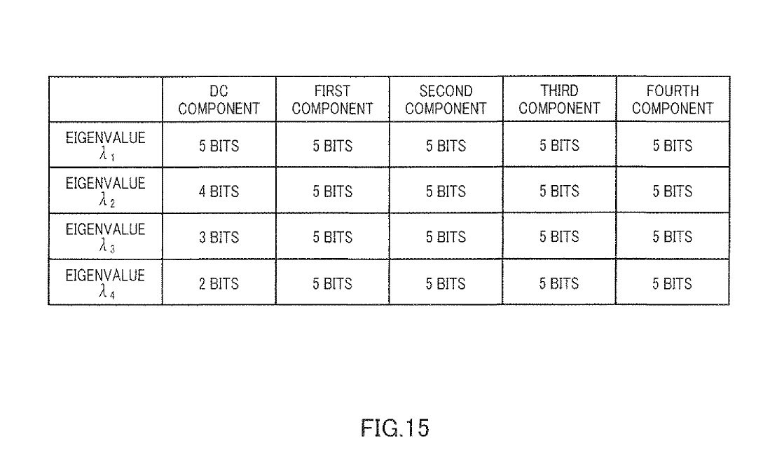

Feedback information generation section 104 is provided with a feedback bit table in which number of CQI DC component quantization bits Xₖ is decreased as eigenvalue number k increases, as shown in FIG. 15. Here, it is assumed that number of CQI DC component quantization bits X₁ for eigenvalue λ₁ is 5, number of CQI DC component quantization bits X₂ for eigenvalue λ₂ is 4, number of CQI DC component quantization bits X₃ for eigenvalue λ₃ is 3, and number of CQI DC component quantization bits X₄ for eigenvalue λ₄ is 2. This is because, as shown in FIG. 9, the average value of an eigenvalue decreases—that is, the DC component value decreases—as eigenvalue number k increases. It is also assumed that number of frequency components Mₖ is 4, and number of frequency component quantization bits Yₖ is 5.

Feedback information generation section 104 quantizes a DCT-converted CQI DC component based on number of frequency components Mₖ and number of frequency component quantization bits Yₖ in the feedback bit table shown in FIG. 15, and generates feedback information together with the quantized DC component.

In this way, the number of feedback bits can be reduced by decreasing number of CQI DC component quantization bits Xₖ as eigenvalue number k increases.

Feedback information demodulation section 203 in FIG. 11 is provided with the same feedback bit table as shown in FIG. 15, and finds an eigenvalue for each RB by performing IDCT conversion of feedback information output from radio reception section 202 based on the feedback bit table. Feedback information demodulation section 203 decides a channel coding rate and modulation level from a found eigenvalue, and outputs the channel coding rate to encoding sections 204-1 through 204-4, and the modulation level to modulation sections 205-1 through 205-4.

Thus, according to Embodiment 4, when CQI feedback is performed based on DCT reporting, the amount of CQI feedback can be reduced by decreasing the number of CQI DC component quantization bits as the eigenvalue number increases.

### Embodiment 5

The configurations of a reception apparatus and transmission apparatus according to Embodiment 5 of the present invention are similar to the configurations shown in FIG. 7 and FIG. 11 of Embodiment 1, with only some functions differing, and therefore FIG. 7 and FIG. 11 are used here and duplicate descriptions are omitted.

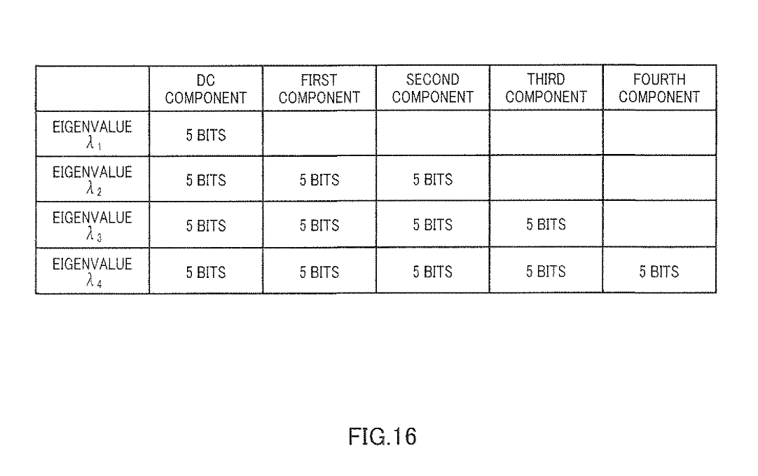

Feedback information generation section 104 and feedback information demodulation section 203 according to Embodiment 5 of the present invention are provided with a feedback bit table in which number of DCT-converted CQI frequency components Mₖ is decreased as eigenvalue number k decreases, as shown in FIG. 16. Here, it is assumed that number of frequency components M₁ for eigenvalue λ₁ is 0, number of frequency components M₂ for eigenvalue λ₂ is 2, number of frequency components M₃ for eigenvalue λ₃ is 3, and number of frequency components M₄ for eigenvalue λ₄ is 4. This is because, as shown in FIG. 9, the eigenvalue fluctuation cycle in the frequency domain lengthens as eigenvalue number k decreases. It is also assumed that the number of DC component quantization bits is 5, and the number of frequency component quantization bits is 5.

Thus, according to Embodiment 5, when CQI feedback is performed based on DCT reporting, the amount of CQI feedback can be reduced by decreasing the number of DCT-converted CQI frequency components as the eigenvalue number decreases.

### Embodiment 6

The configurations of a reception apparatus and transmission apparatus according to Embodiment 6 of the present invention are similar to the configurations shown in FIG. 7 and FIG. 11 of Embodiment 1, with only some functions differing, and therefore FIG. 7 and FIG. 11 are used here and duplicate descriptions are omitted.

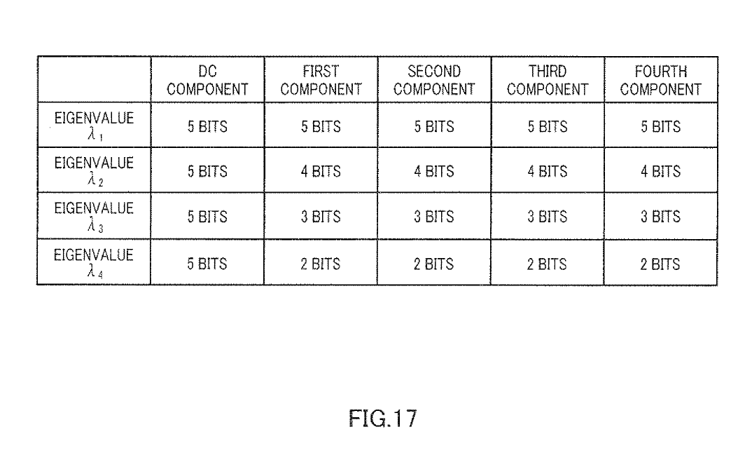

Feedback information generation section 104 and feedback information demodulation section 203 according to Embodiment 6 of the present invention are provided with a feedback bit table in which number of frequency component quantization bits Yₖ is decreased as eigenvalue number k increases, as shown in FIG. 17. Here, it is assumed that number of frequency component quantization bits Y₁ for eigenvalue λ₁ is 5, number of frequency component quantization bits Y₂ for eigenvalue λ₂ is 4, number of frequency component quantization bits Y₃ for eigenvalue λ₃ is 3, and number of frequency component quantization bits Y₄ for eigenvalue λ₄ is 2. This is because the influence of CQI feedback precision on link adaptation precision decreases as eigenvalue number k increases. It is also assumed that the number of DC component quantization bits is 5, and the number of frequency components that are fed back is 4.

Thus, according to Embodiment 6, when CQI feedback is performed based on DCT reporting, the amount of CQI feedback can be reduced by decreasing the number of frequency component quantization bits as the eigenvalue number increases.

### Embodiment 7

The configurations of a reception apparatus and transmission apparatus according to Embodiment 7 of the present invention are similar to the configurations shown in FIG. 7 and FIG. 11 of Embodiment 1, with only some functions differing, and therefore FIG. 7 and FIG. 11 are used here and duplicate descriptions are omitted.

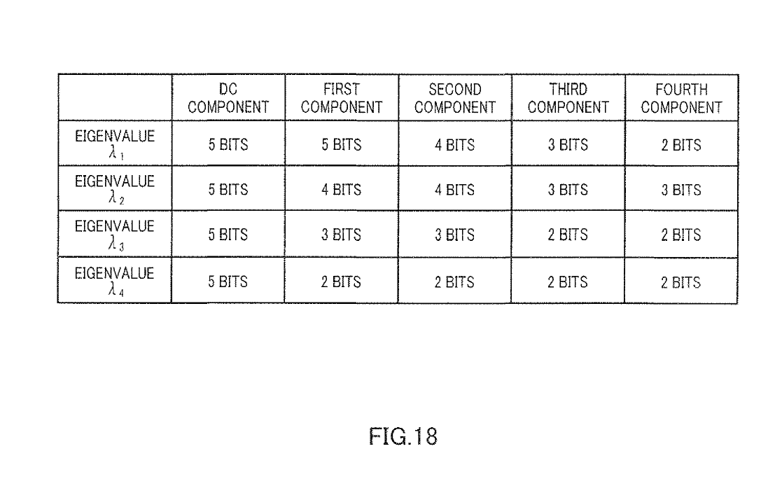

Feedback information generation section 104 and feedback information demodulation section 203 according to Embodiment 7 of the present invention are provided with a feedback bit table as shown in FIG. 18 in which number of frequency component quantization bits Yₖ is decreased as DCT-converted CQI frequency component number n increases, and the interval at which number of quantization bits Yₖ of other frequency components is decreased with respect to the first frequency component (“FIRST COMPONENT” in FIG. 18) is increased as eigenvalue number k decreases.

Here, it is assumed that, for eigenvalue λ₁, number of first frequency component quantization bits Y₁ is 5, number of second frequency component quantization bits Y₂ is 4, number of third frequency component quantization bits Y₃ is 3, and number of fourth frequency component quantization bits Y₄ is 2. For eigenvalue λ₂ it is assumed that number of first and second frequency component quantization bits Y₂ is 4, and number of third and fourth frequency component quantization bits Y₂ is 3. For eigenvalue λ₃ it is assumed that number of first and second frequency component quantization bits Y₃ is 3, and number of third and fourth frequency component quantization bits Y₃ is 2. And for eigenvalue λ₄ it is assumed that number of quantization bits Y₄ is 2 for all of the first through fourth frequency components. It is also assumed that the number of DC component quantization bits is 5, and the number of frequency components that are fed back is 4.

The reason for decreasing number of frequency component quantization bits Yₖ as DCT-converted CQI frequency component number n increases is that the influence on CQI feedback precision decreases as frequency component number n increases. The reason for increasing the interval at which number of quantization bits Yₖ of other frequency components is decreased with respect to the first frequency component (“FIRST COMPONENT” in FIG. 18) as eigenvalue number k decreases is that eigenvalue frequency selectivity lessens, and power is biased toward a DCT low-frequency component, as eigenvalue number k decreases.

Thus, according to Embodiment 7, when CQI feedback is performed based on DCT reporting, the amount of CQI feedback can be reduced by decreasing the number of frequency component quantization bits as the DCT-converted CQI frequency component number increases, and increasing the interval at which the number of quantization bits of other frequency components is decreased with respect to the first frequency component as the eigenvalue number decreases.

### Embodiment 8

The configurations of a reception apparatus and transmission apparatus according to Embodiment 8 of the present invention are similar to the configurations shown in FIG. 7 and FIG. 11 of Embodiment 1, with only some functions differing, and therefore FIG. 7 and FIG. 11 are used here and duplicate descriptions are omitted.

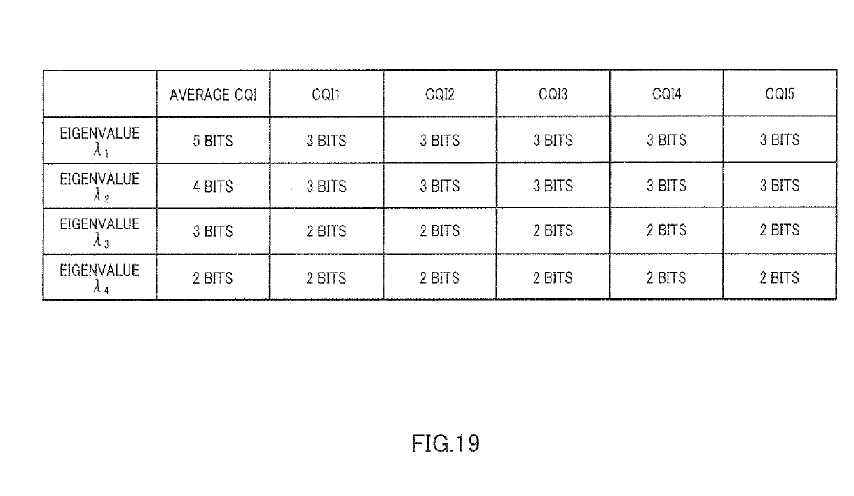

Feedback information generation section 104 and feedback information demodulation section 203 according to Embodiment 8 of the present invention are provided with a feedback bit table in which number of average CQI quantization bits Xₖ and number of CQI quantization bits Yₖ are decreased as eigenvalue number k increases, as shown in FIG. 19. Here, it is assumed that the average CQI of eigenvalue λ₁ is 5 bits, the average CQI of eigenvalue λ₂ is 4 bits, and numbers of quantization bits Y₁ and Y₂ of CQIs fed back for eigenvalue λ₁ and eigenvalue λ₂ are 3. Also, it is assumed that the average CQI of eigenvalue λ₃ is 3 bits, the average CQI of eigenvalue λ₄ is 2 bits, and numbers of quantization bits Y₃ and Y₄ of CQIs fed back for eigenvalue λ₃ and eigenvalue λ₄ are 2.

Thus, according to Embodiment 8, when CQI feedback is performed based on Best-M reporting, the amount of CQI feedback can be reduced by decreasing the number of average CQI quantization bits and the number of CQI quantization bits as the eigenvalue number increases.

### Embodiment 9

The configurations of a reception apparatus and transmission apparatus according to Embodiment 9 of the present invention are similar to the configurations shown in FIG. 7 and FIG. 11 of Embodiment 1, with only some functions differing, and therefore FIG. 7 and FIG. 11 are used here and duplicate descriptions are omitted.

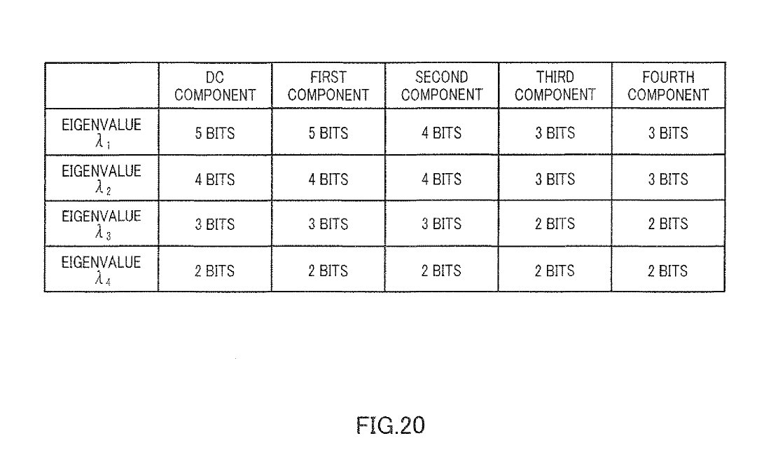

Feedback information generation section 104 and feedback information demodulation section 203 according to Embodiment 9 of the present invention are provided with a feedback bit table as shown in FIG. 20 in which number of CQI DC component quantization bits Xₖ, number of frequency component quantization bits Yₖ, and number of quantization bits Yₖ of the first frequency component (“FIRST COMPONENT” in FIG. 20) are decreased as eigenvalue number k increases, and number of frequency component quantization bits Yₖ is decreased as DCT-converted CQI frequency component number n increases.

Here, it is assumed that, for eigenvalue λ₁, the number of DC component quantization bits is 5, number of first frequency component quantization bits Y₁ is 5, number of second frequency component quantization bits Y₁ is 4, number of third frequency component quantization bits Y₁ is 3, and number of fourth frequency component quantization bits Y₁ is 2. For eigenvalue λ₂ it is assumed that the number of DC component quantization bits is 4, number of first and second frequency component quantization bits Y₂ is 4, and number of third and fourth frequency component quantization bits Y₂ is 3. For eigenvalue λ₃ it is assumed that the number of DC component quantization bits is 3, number of first and second frequency component quantization bits Y₃ is 3, and number of third and fourth frequency component quantization bits Y₃ is 2. And for eigenvalue λ₄ it is assumed that the number of DC component quantization bits is 2, and number of quantization bits Y₄ is 2 for all of the first through fourth frequency components. It is also assumed that the number of frequency components that are fed back is 4.

Thus, according to Embodiment 9, when CQI feedback is performed based on DCT reporting, the amount of CQI feedback can be reduced by decreasing the number of CQI DC component quantization bits and the number of frequency component quantization bits as the eigenvalue number increases, decreasing the number of frequency component quantization bits as the DCT-converted CQI frequency component number increases, and increasing the interval at which the number of quantization bits of other frequency components is decreased with respect to the first frequency component as the eigenvalue number decreases.

In the above embodiments, cases have been described by way of example in which the present invention is configured as hardware, but it is also possible for the present invention to be implemented by software.

The function blocks used in the descriptions of the above embodiments are typically implemented as LSIs, which are integrated circuits. These may be implemented individually as single chips, or a single chip may incorporate some or all of them. Here, the term LSI has been used, but the terms IC, system LSI, super LSI, and ultra LSI may also be used according to differences in the degree of integration.

The method of implementing integrated circuitry is not limited to LSI, and implementation by means of dedicated circuitry or a general-purpose processor may also be used. An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The disclosure of Japanese Patent Application No. 2008-056555, filed on Mar. 6, 2008, including the specification, drawings and abstract, is incorporated herein by reference in its entirety.

### INDUSTRIAL APPLICABILITY

A radio reception apparatus and feedback method according to the present invention enable the amount of CQI feedback in a MIMO channel to be reduced, and are suitable for use in a mobile communication system or the like, for example.

1. A radio reception apparatus comprising:
a reception section that receives via a plurality of reception antennas a signal transmitted from a plurality of transmission antennas;
a channel estimation section that estimates a channel matrix between the plurality of transmission antennas and the plurality of reception antennas using a pilot signal in the received signal, and finds an eigenvalue by performing an eigenvalue decomposition of the estimated channel matrix;
a feedback information generation section that converts the found eigenvalue to a CQI for each eigenvalue number, reduces a number of quantization bits of an average CQI in each stream, a number of top CQIs that are fed back, or a number of top CQI quantization bits using a number corresponding to the eigenvalue number, and generates CQI feedback information; and
a transmission section that transmits the generated feedback information.

2. The reception apparatus according to claim 1, wherein the feedback information generation section generates the CQI feedback information by reducing the number of quantization bits of the average CQI to a greater extent the larger the eigenvalue number is.

3. The reception apparatus according to claim 1, wherein the feedback information generation section generates the CQI feedback information by reducing the number of top CQIs to a greater extent the smaller the eigenvalue number is.

4. The reception apparatus according to claim 1, wherein the feedback information generation section generates the CQI feedback information by reducing the number of top CQI quantization bits to a greater extent the larger the eigenvalue number is.

5. A radio reception apparatus comprising:
a reception section that receives via a plurality of reception antennas a signal transmitted from a plurality of transmission antennas;
a channel estimation section that estimates a channel matrix between the plurality of transmission antennas and the plurality of reception antennas using a pilot signal in the received signal, and finds an eigenvalue by performing an eigenvalue decomposition of the estimated channel matrix;
a feedback information generation section that performs DCT conversion of the found eigenvalue for each eigenvalue number, reduces a number of quantization bits of a DC component in each stream, a number of frequency components other than the DC component, or a number of quantization bits of a frequency component other than the DC component using a number corresponding to the eigenvalue number, and generates CQI feedback information; and
a transmission section that transmits the generated feedback information.

6. The reception apparatus according to claim 5, wherein the feedback information generation section generates the CQI feedback information by reducing the number of quantization bits of the DC component to a greater extent the larger the eigenvalue number is.

7. The reception apparatus according to claim 5, wherein the feedback information generation section generates the CQI feedback information by reducing the number of frequency components other than the DC component to a greater extent the smaller the eigenvalue number is.

8. The reception apparatus according to claim 5, wherein the feedback information generation section generates the CQI feedback information by reducing the number of quantization hits of the frequency component other than the DC component to a greater extent the larger the eigenvalue number is.

9. The reception apparatus according to claim 5, wherein the feedback information generation section generates the CQI feedback information by reducing the number of quantization bits of the frequency component to a greater extent the higher the frequency component is.

10. The reception apparatus according to claim 9, wherein the feedback information generation section generates the CQI feedback information by increasing a size of reduction of a number of quantization bits of a lowest frequency component other than the DC component the smaller the eigenvalue number is.

11. A feedback method comprising:
estimating a channel matrix between a plurality of transmission antennas and a plurality of reception antennas, and finding an eigenvalue by performing an eigenvalue decomposition of the estimated channel matrix;
converting the found eigenvalue to a CQI for each eigenvalue number, reducing a number of quantization bits of an average CQI in each stream, a number of top CQIs that are fed back, or a number of top CQI quantization bits using a number corresponding to the eigenvalue number, and generating CQI feedback information; and
transmitting the generated feedback information.
